(19) United States
(12) Patent Application Publication
(10) Pub. No.: US 2012/0206760 A1
(43) Pub. Date: Aug. 16, 2012

(54) NETWORK SYSTEM, PROGRAM SET DISTRIBUTION METHOD, DISTRIBUTION SERVER, DISTRIBUTION SERVER CONTROL METHOD, AND STORAGE MEDIUM

(75) Inventor: Hideo Asahara, Yokohama-shi (JP)

(73) Assignee: CANON KABUSHIKI KAISHA, Tokyo (JP)

(21) Appl. No.: 13/358,104

(22) Filed: Jan. 25, 2012

(30) Foreign Application Priority Data
Feb. 15, 2011 (JP) 2011-029518

(51) Int. Cl. G06F 3/12

(52) U.S. Cl. 358/1.15

(57) ABSTRACT

A distribution managing server determines whether or not an image forming apparatus has already corresponded to an encoding scheme of request firmware requested by the image forming apparatus, and establishes a first communication path having a higher security level than that of a second communication path when the image forming apparatus has not yet corresponded to the encoding scheme. Then, the firmware providing server distributes a decoder module, which is applied to the image forming apparatus so as to correspond to the encoding scheme, to the image forming apparatus using the first communication path, and distributes the request firmware to the image forming apparatus using the second communication path.

### BACKGROUND OF THE INVENTION

1. Field of the Invention

The present invention relates to a network system, a program set distribution method, a distribution server, a distribution server control method, and a storage medium.

2. Description of the Related Art

A distribution server for distributing new firmware to be updated to an image forming apparatus has been proposed. Firmware includes various technologies and intellectual properties, and thus, must not be seen by third parties. Thus, it is contemplated that a distribution server encrypts firmware and then distributes the encoded, firmware to an image forming apparatus, and the decoding function provided in firmware running on the image processing apparatus decodes the encoded firmware for update.

Accompanying the advancement of a decoding technique for encoded data, a firmware encoding scheme may change. In such case, there is no method for distributing firmware corresponding to a new encoding scheme to an image forming apparatus in a secured manner. Thus, currently, an encoding scheme for firmware for any product that has once shipped to the market is not to be changed. If an encoding scheme for firmware needs to be replaced for some unexpected reason, service persons must visit all of the locations at which image forming apparatuses have been located and manually update firmware.

Japanese Patent Laid-Open No. 2001-127749 discloses a system in which a center apparatus for holding the old and new encoding scheme identification information receives encryption identification information from a communication terminal and updates the received encryption identification information to the latest encoding scheme identification information by decoding and verifying the received encryption identification information using one of the old and new encoding scheme identification information.

When service persons manually update firmware, service persons need to visit ail of the locations at which image forming apparatuses have been located for maintenance purpose. Thus, the enormous amount of human and time costs is required. As a premise for updating firmware using this manual method, firmware to be updated, needs to be encoded by the pre-changed encoding scheme. In other words, since the post-changed encoding scheme is protected by the pre-changed encoding scheme, the security of the post-changed encoding scheme may undesirably be damaged if the pre-changed encoding scheme is leaked to the outside.

In addition, if the technology disclosed in Japanese Patent Laid-Open No. 2001-127749 is applied to the distribution of firmware, i.e., a program set, to an image forming apparatus, the following situation may arise. In other words, when firmware, which a user wishes to update, is encoded by a new encoding scheme that cannot be decoded by the decoding function held by the image forming apparatus, firmware cannot be updated.

### SUMMARY OF THE INVENTION

The present invention provides a network system in which an image forming apparatus, which does not correspond, to a new encoding scheme, is capable of decoding and updating a program set to be updated encoded by the new encoding scheme.

The network system of an present invention includes an image forming apparatus and a distribution server that distributes an encoded program set to the image forming apparatus. The distribution server includes a determination unit configured to determine whether or not the image forming apparatus has already corresponded to an encoding scheme of the program set, a communication path establishment unit configured to establish a first communication path having a higher security level than that of a second communication path when the image forming apparatus has not yet corresponded to the encoding scheme of the program set, and a distribution unit configured to distribute a program, which is applied to the image forming apparatus so as to correspond to the encoding scheme, to the image forming apparatus using the first communication path and to distribute the program set encoded by the encoding scheme to the image forming apparatus using the second communication path.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a network system of the present embodiment.

FIG. 2 is a diagram illustrating the function of a network system of a first embodiment.

FIG. 3 is a diagram illustrating an example of a firmware update request.

FIG. 4 is a diagram illustrating an example of a firmware download address list.

FIG. 5 is a diagram illustrating an example of a firmware list.

FIG. 6 is a diagram illustrating an example of a decoder module list.

FIG. 7 is a flowchart illustrating an example of firmware update request transmission processing.

FIG. 8 is a flowchart illustrating an example of firmware download address list generation processing.

FIG. 9 is a flowchart illustrating an example of firmware update processing.

### DESCRIPTION OF THE EMBODIMENTS

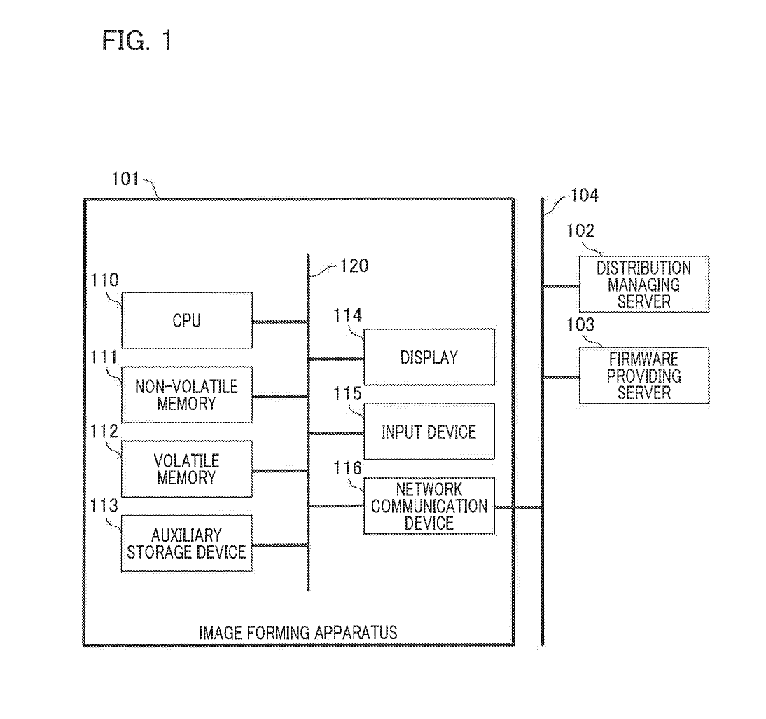

FIG. 1 is a diagram illustrating an example of the configuration of a network system of the present embodiment. The network system includes an image forming apparatus 101, a distribution managing server 102, and a firmware providing server 103. The image forming apparatus 101 to the firmware providing server 103 are allowed for communication to each other via a network 104. The network 104 is, for example, Internet. The program set distribution method of the present embodiment is realized by the functions of the units included by the network system shown in FIG. 1.

The image forming apparatus 101 is an information processing apparatus that executes print processing for print data input via an external device or a predetermined interface. The image forming apparatus 101 is, for example, a printer. The image forming apparatus 101 includes firmware that is software for realizing the functions of the image forming apparatus 101. Firmware is a program set (a set of one or more software). In the present embodiment, firmware includes software for updating firmware, and software for decoding the encoded firmware. In the following description, software for decoding the encoded firmware is described as a “decoder module”. The size of the decoder module is small in comparison with other software configuring firmware. Also, software for updating firmware is described as “update software”.

The image forming apparatus 101 includes a CPU 110, a non-volatile memory 111, a volatile memory 112, an auxiliary storage device 113, a display 114, an input device 115, and a network communication device 116.

The CPU 110 controls the image forming apparatus 101 overall. More specifically, the CPU 110 executes a storage medium for realizing the functions of the image forming apparatus 101, or executes the control of the units connected via an internal bus 120.

The non-volatile memory 111 has a ROM (Read Only Memory). The non-volatile memory 111 stores a program and data, which are required at the initial stage of activation processing of the image forming apparatus 101, in advance. The volatile memory 112 has a RAM (Random Access Memory). The volatile memory 112 is used as a storage location for temporarily storing a program and data.

The auxiliary storage device 113 is configured by a mass storage device such as a hard disk, an RAM drive, or the like, and stores large-capacity data and holds a program executable code. The auxiliary storage device 113 stores data that is necessary for being held for a long time in comparison with the volatile memory 112. More specifically, the auxiliary storage device 113 holds firmware run on the image forming apparatus 101. The display 114 is a display device that notifies information to a user who operates the image forming apparatus 101.

The input device 115 is a device that receives a user's selection instruction and transmits the user's selection instruction to a program executed by the CPU 110 via the internal bus 120. The network communication device 116 mediates communication between the image forming apparatus 101 and an external device. In other words, the network communication device 116 communicates with an external device via the network 104 in accordance with an instruction given by the CPU 110.

The distribution managing server 102 is a server that manages the distribution of firmware from the firmware providing server 103 to the image forming apparatus 101. The firmware providing server 103 is a server that provides the encoded firmware to the image forming apparatus 101 via the network 104.

In other words, the distribution managing server 102 and the firmware providing server 103 collectively function as a distribution server that distributes the encoded, program set to the image forming apparatus 101. For this purpose, the firmware providing server 103 holds firmware run on the image forming apparatus 101 in a downloadable state.

The firmware providing server 103 establishes a secure communication path (first communication path) according to HTTPS and a normal communication path (second communication path) according to HTTP, and distributes firmware to the image forming apparatus 101 using the established communication paths, where HTTP is an abbreviation for Hypertext Transfer Protocol and HTTPS is an abbreviation for Hypertext Transfer Protocol Security. When HTTPS is compared with HTTP, HTTPS is somewhat slower than HTTP and the cost for renting the firmware providing server 103 using HTTPS is also higher than that using HTTP. On the other hand, HTTPS provides a security level (ensures security) higher than that of HTTP.

FIG. 1 shows one firmware providing server 103. However, the network system of the present embodiment has a framework for distributing access to a plurality of firmware provision servers. With this arrangement, firmware may be provided to worldwide in a quick and stable manner.

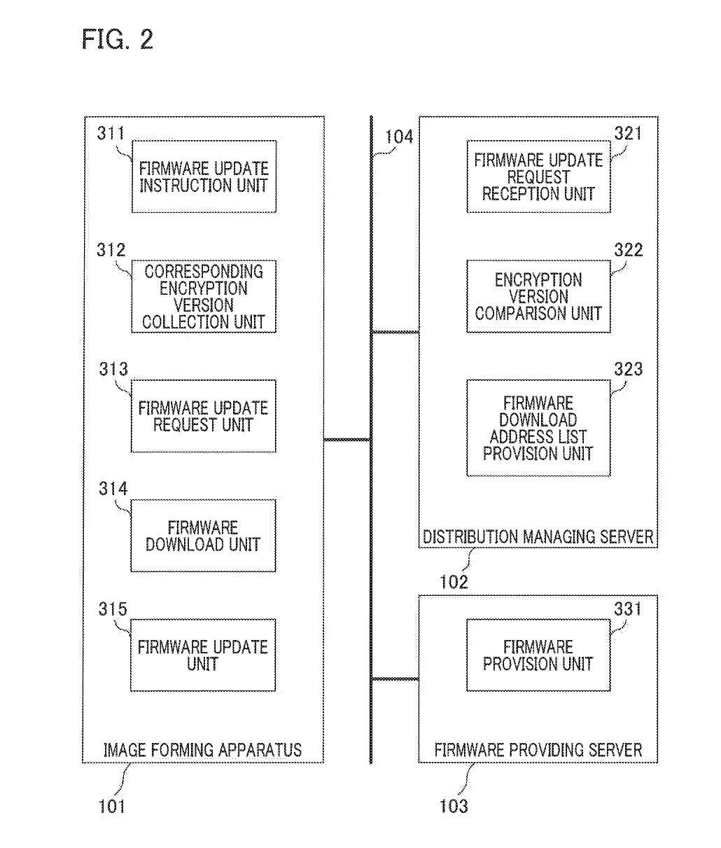

FIG. 2 is a diagram illustrating the function of a network system of a first embodiment. The image forming apparatus 101 includes a firmware update instruction unit 311, a corresponding encryption version collection unit 312, a firmware update request unit 313, a firmware download unit 314, and a firmware update unit 315.

The firmware update instruction unit 311 provides a firmware update instruction based on input information input by the input device 115 (FIG. 1) in accordance with a user's operation. The firmware update instruction is an instruction for updating firmware. The corresponding encryption version collection unit 312 acquires the version of an encoding scheme of firmware or software, by which firmware currently running on the image forming apparatus 101 can be decoded. In the following, firmware currently running on the image forming apparatus 101 is described as “current firmware”. Also, an encoding scheme of firmware or software by which current firmware can be decoded is described as a “current firmware-corresponding encoding scheme”.

In the present embodiment, the auxiliary storage device 113 stores firmware as well as a version of a current firmware-corresponding encoding scheme. Thus, the corresponding encryption version collection unit 312 reads out a version of a current firmware-corresponding encoding scheme from the auxiliary storage device 113 and acquires it. In the following, a version of a current firmware-corresponding encoding scheme is also described as a “corresponding encryption version”.

The firmware update request unit 313 receives a firmware update, instruction from the firmware update instruction unit 311. Then, the firmware update request unit 313 makes a firmware update request to the distribution managing server 102. A firmware update request is a request for distributing firmware desired to be newly updated and applied.

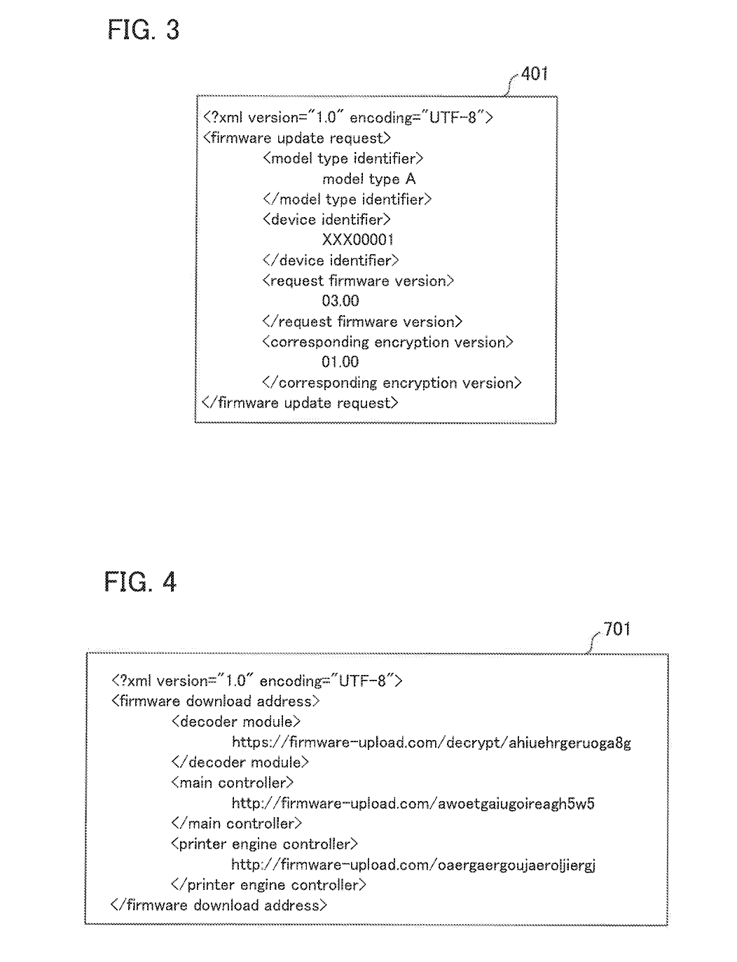

FIG. 3 is a diagram illustrating an example of a firmware update request made by a firmware update request unit. A firmware update request 401 has data in XML format. The firmware update request unit 313 sets a model type identifier, a device identifier, a request, firmware version, and a corresponding encryption version in a firmware update request tag.

The model type identifier is identification information for uniquely identifying the model type of an image forming apparatus. In this example, the model type identifier of the image forming apparatus 101 is a model type A. The device identifier is identification information for uniquely identifying an image forming apparatus itself. In this example, the device identifier of the image forming apparatus 101 is XXX00001.

The request firmware version is a version of firmware requested for distribution by the image forming apparatus 101. The image forming apparatus 101 replaces firmware running on the image forming apparatus 101 with the distributed firmware for update. The version is intended to be unique for each model type. In this example, the request firmware version is 03.00. Thus, the firmware update request 401 indicates a request for distributing firmware version 03.00 to the distribution managing server 102. The firmware update request, unit 313 acquires a corresponding encryption version from the corresponding encryption version collection unit 312 and sets it to the firmware update request 401. In this example, the corresponding encryption version 01.00 is set to the firmware update request 401. Thus, it is indicated that the image forming apparatus 101 corresponds to firmware or software encoded by the encoding scheme of the corresponding encryption version 01.00, that is, the image forming apparatus 101 can decode the firmware or software.

Referring back to FIG. 2, the firmware download unit 314 acquires a firmware download address list from the distribution managing server 102 via the network 104. The firmware download address list is a list of the download addresses of firmware to be distributed to the image forming apparatus 101. Then, the firmware download unit 314 downloads firmware based on the download addresses included in the acquired firmware download address list.

FIG. 4 is a diagram illustrating an example of a firmware download address list. A firmware download address list 701 has data in XML format. In the example shown in FIG. 4, firmware (hereinafter referred to as “download target firmware”) to be downloaded by the image forming apparatus 101 is intended to include a decoder module, a main controller, and a printer engine controller.

Here, when the corresponding encryption version does not match the encoded version of firmware requested by the firmware update request, the distribution managing server 102 executes the following processing. The distribution managing server 102 sets the download address of a decoder module, which corresponds to the encoding scheme of firmware (request firmware) requested by the firmware update request, to the firmware download address list. The decoder module included in the firmware download address list 701 can decode software (in this example, the main controller and the printer engine controller), which is included in the download target firmware, other than the decoder module. In other words, the decoder module is a program that is applied to the image forming apparatus 101 so as to correspond to the encoding scheme of request firmware.

In this example, a decoder module tag, a main controller tag, and a printer engine controller tag are set under the firmware download address tag. The download address of the decoder module is set under the decoder module tag. The download address of the main controller is set under the main controller tag. The download address of the printer engine controller is set under the printer engine controller tag. The firmware providing server 103 manages these download addresses.

The download address of the decoder module is the address of HTTPS. In other words, when the image forming apparatus 101 downloads a decoder module from the firmware providing server 103, a secure communication path (first communication path) has already been established. With this arrangement, security is ensured during downloading the decoder module from the firmware providing server 103. The download address of the main controller and the download address of the printer engine controller are the addresses of HTTP. In other words, when the image forming apparatus 101 downloads a main controller and a printer engine controller from the firmware providing server 103, the image forming apparatus 101 downloads them using a normal communication path (second communication path).

Referring back to FIG. 2, the firmware update unit 315 updates firmware (current, firmware) currently running on the image forming apparatus 101 using firmware downloaded by the firmware download unit 314.

When the downloaded firmware includes a decoder module, the firmware update unit 315 first performs decoder module update processing using current firmware. More specifically, the firmware update unit 315 decodes the decoder module included in the downloaded firmware using the decoder module included in current firmware. The firmware update unit 315 updates the decoder module included in the current firmware with the decoded decoder module. With this arrangement, the updated decoder module is in a ready-for-operation state. Next, the firmware update unit 315 decodes software (for example, a printer driver controller), which is included in the downloaded firmware, other than the decoder module using the updated decoder module. Then, the firmware update unit 315 updates software included in current firmware with the decoded software.

The distribution managing server 102 includes a firmware update request reception unit 321, an encryption version comparison unit 322, and a firmware download address list provision unit 323. The firmware update request reception unit 321 receives a firmware update request from the firmware update request unit 313 of the image forming apparatus 101.

The encryption version comparison unit 322 determines whether or not the image forming apparatus 101 can decode request firmware. In other words, the encryption version comparison unit 322 functions as a determination unit that determines whether or not the image forming apparatus 101 has already corresponded to the encoding scheme of request firmware.

The encryption version comparison unit 322 determines whether or not the corresponding encryption version included in a firmware update request matches the version of the encoding scheme of request firmware, and determines whether or not download target firmware can be decoded based on the determination result. In the following, the version of the encoding scheme of request firmware is described as an “encoded version”. The encoded version is included in the firmware list stored in a storage unit in advance.

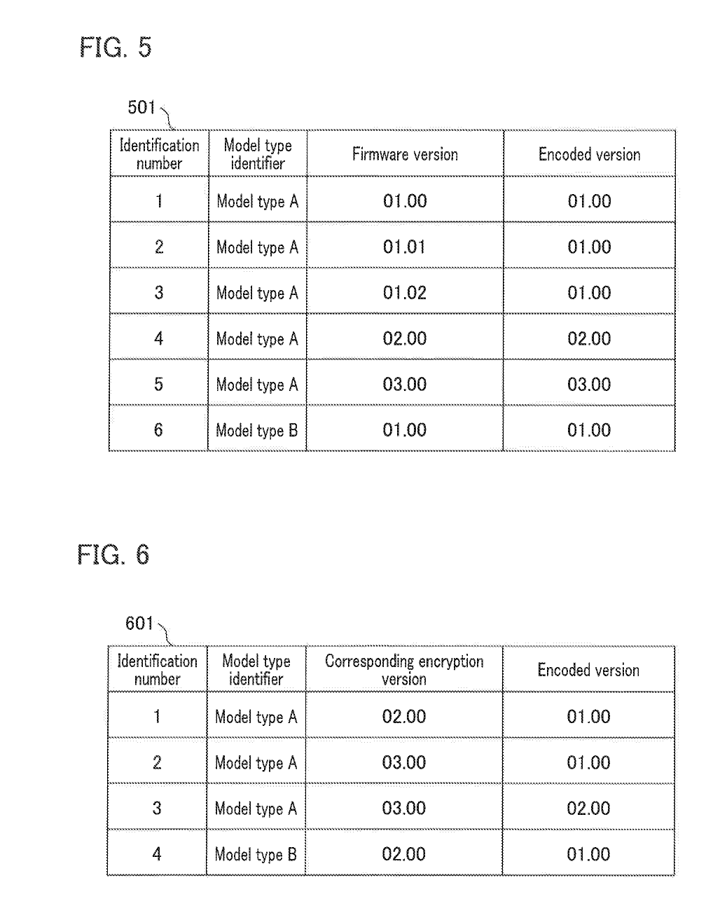

FIG. 5 is a diagram illustrating an example of a firmware list. A firmware list 501 includes a identification number, a model type identifier, a firmware version, and an encoded version. The identification number is identification information for uniquely identifying firmware that can be provided by a firmware provision server. The model type identifier means the same as the model type identifier described with reference to FIG. 3.

The firmware version is a version of firmware that can be provided by the firmware providing server 103. The encoded version is a version of the encoding scheme of firmware that can be provided by the firmware providing server 103.

Referring back to FIG. 2, the encryption version comparison unit 322 acquires, for example, the request, firmware version and the model type identifier included in the firmware update request 401 shown in FIG. 3. In this example, the encryption version comparison unit 322 acquires the request firmware version 03.00 and the model type identifier of the model type A. Next, the encryption version comparison unit 322 searches an entry of which the model type identifier is the model type A and the firmware version is 03.00 among the entries (one row data) of the firmware list 501 shown in FIG. 5. In this example, the encryption version comparison unit 322 acquires the entry of which the identification number is five as the search result. Firmware corresponding to the entry of which the identification number is five is request firmware.

Next, the encryption version comparison unit 322 acquires the encoded version included in the acquired entry, that is, the encoded version of request firmware. In this example, the encryption version comparison unit 322 acquires 03.00 as the encoded version. Also, the encryption version comparison unit 322 acquires the corresponding encryption version included in the firmware update request 401. In this example, the encryption version comparison unit 322 acquires 01.00 as the corresponding encryption version. Then, the encryption version comparison unit 322 determines whether or not the acquired corresponding encryption version matches the acquired encoded version.

When the corresponding encryption version matches the encoded version, the encryption version comparison unit 322 determines that the image forming apparatus 101 can decode request firmware. When the corresponding encryption version does not match the encoded version, the encryption version comparison unit 322 determines that the Image forming apparatus 101 cannot decode request firmware. In this example, since the encoded version is 03.00 and the corresponding encryption version is 01.00, the encoded version does not match the corresponding encryption version. Thus, the encryption version comparison unit 322 determines that the image forming apparatus 101 cannot decode request firmware.

Referring back to FIG. 2, a firmware download address list provision unit (hereinafter referred to as a “provision unit”) 323 generates a firmware download address list. When the encryption version comparison unit 322 determines that the image forming apparatus 101 can decode request firmware, the provision unit 323 set request firmware to download target firmware. Then, the provision unit 323 generates a list of the download addresses of the download, target firmware (request firmware) as a firmware download address list.

When the encryption version comparison unit 322 determines that the image forming apparatus 101 cannot decode request firmware, the provision unit 323 refers to a decoder module list stored in a predetermined storage unit in advance, and executes the following processing. The provision unit 323 selects a decoder module, which can be decoded by the image forming apparatus 101 and corresponds to the encoding scheme of request firmware, and sets the selected decoder module and request firmware as download target firmware. Then, the provision unit 323 generates a list of the download addresses of the download target firmware (decoder module and request firmware) as a firmware download address list.

FIG. 6 is a diagram illustrating an example of a decoder module list. A decoder module list 601 includes an identification number, a model type identifier, a corresponding encryption version, and an encoded version. The identification number is identification information for uniquely identifying a decoder module provided by the firmware providing server 103. The model type identifier is the same as the model type identifier described with reference to FIG. 3. The corresponding encryption version is a version of the encoding scheme corresponding to the decoder module, that is, a version of the encoding scheme of firmware or software that can be decoded by the decoder module. The encoded version is a version of the encoding scheme of the decoder module itself.

With reference to FIGS. 3 to 6, a specific description will be given by taking an example of processing performed by the provision unit 323. It is assumed that firmware that corresponds to the identification number five of the firmware list 501 shown in FIG. 5 is request firmware. Since the encoded version “03.00” of the request firmware does not match the corresponding encryption version “01.00” included in the firmware update request 401 shown in FIG. 3, the encryption version comparison unit 322 determines that the image forming apparatus 101 cannot decode request firmware.

Among the entries of the decoder module list shown in FIG. 6, the provision unit 323 searches an entry of which the corresponding encryption version matches the encoded version “03.00” of the request firmware and of which the encoded version matches the corresponding encryption version “01.00”. In this example, the provision unit 323 acquires the entry having the identification number of two as the search result, and determines the download address of the decoder module corresponding to the acquired entry as the setting target to the firmware download address list.

For example, assume the case where request firmware includes a main controller and a printer engine controller. The provision unit 323 acquires the download address of the controller and the download address of the decoder module from the firmware providing server 103, and sets the acquired download address to the firmware download address list 701 (see FIG. 4). For this purpose, the provision unit 323 notifies the controller and the decoder module to a firmware provision unit 331 of the firmware providing server 103, and receives the assignment of the download addresses of the controller and the decoder module from, the firmware provision unit 331. Also, the provision unit 323 provides a firmware download address list to the firmware download unit 314 of the image forming apparatus 101 via the network 104.

Referring back to FIG. 2, the firmware providing server 103 includes the firmware provision unit 331. When the firmware provision unit 331 receives request firmware and notification of the decoder module from the provision unit 323 of the distribution managing server 102, the firmware provision unit 331 assigns the download address to request firmware and its decoder module so as to bring the request firmware in a downloadable state. Then, the download address is reported to the provision unit 323.

The firmware provision unit 331 assigns the address of HTTPS to the decoder module. Also, the firmware provision unit 331 assigns the address of HTTP to request firmware. In other words, when download target firmware includes the decoder module and request firmware, the firmware provision unit 331 assigns the address of HTTP to firmware other than the decoder module among firmware included in download target firmware.

In other words, the provision unit 323 of the distribution managing server 102 and the firmware provision unit 331 of the firmware providing server 103 function as a communication path establishment unit that performs the following processing. When the image forming apparatus 101 has not yet corresponded to the encoding scheme of request firmware, the communication path establishment unit assigns the address of HTTPS as the download address of the decoder module. In other words, the communication path establishment unit establishes a first communication path having a higher security level than that of a communication path (second communication path) using the address of HTTP.

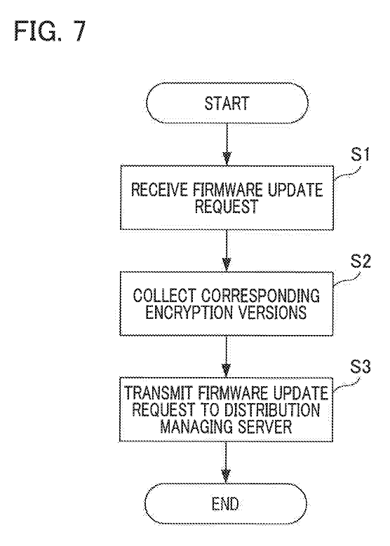

FIG. 7 is a flowchart illustrating an example of firmware update request transmission processing. First, the input device 115 receives a firmware update request in accordance with a user's operation (step S1), and transmits the received firmware update request to the firmware update instruction unit 311.

Next, the corresponding encryption version collection unit 312 collects corresponding encryption versions (step S2). Then, the firmware update request unit 313 transmits the firmware update request 401 including the corresponding encryption versions collected in step S2 to the distribution managing server 102 via the network 104 (step S3).

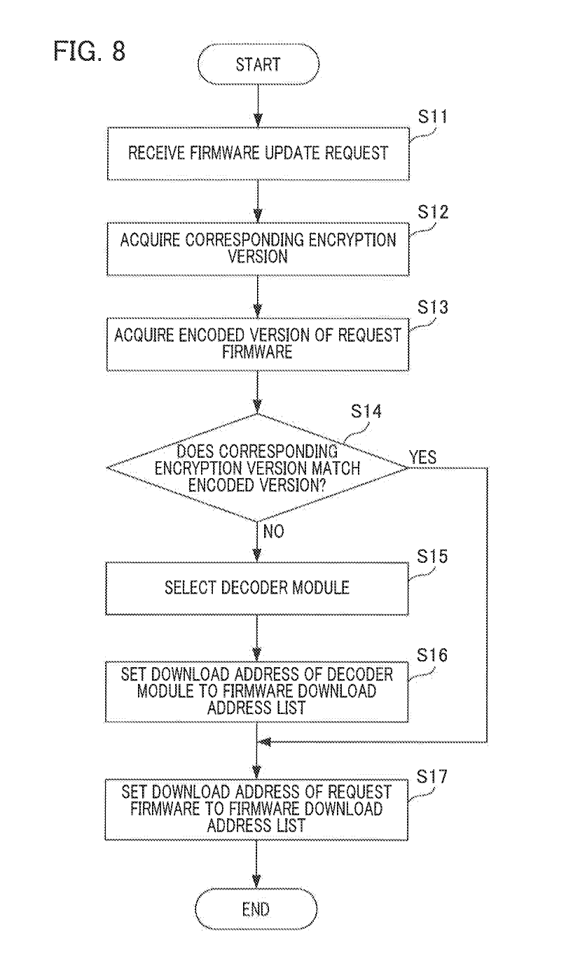

FIG. 8 is a flowchart illustrating an example of firmware download address list generation processing. The firmware update request reception unit 321 of the distribution managing server 102 receives the firmware update request 401 from the firmware update request unit 313 of the image forming apparatus 101 (step S11). Next, the encryption version comparison unit 322 acquires the corresponding encryption version of the image forming apparatus 101 from the firmware update request 401 (step S12).

Next, the encryption version comparison unit 322 acquires a model type identifier and a request firmware version from the firmware update request 401. Then, the encryption version comparison unit 322 refers to the firmware list 501, and selects firmware (request firmware) corresponding to the acquired model type identifier and request firmware version to thereby acquire its encoded version (step S13).

Next, the encryption version comparison unit 322 determines whether or not the corresponding encryption version acquired in step S12 matches the encoded version acquired in step S13 (step S14).

When the encryption version comparison unit 322 determines that the corresponding encryption version matches the encoded version, the process advances to step S17. When the encryption version comparison unit 322 determines that the corresponding encryption version does not match the encoded version, the process advances to step S15.

The encryption version comparison unit 322 selects a decoder module of which the encoded version matches the corresponding encryption version acquired in step S12 and of which the corresponding encryption version matches the encoded version acquired in step S13 (step S15). With this arrangement, firmware including the selected decoder module and request firmware is determined as download target firmware.

Next, the encryption version comparison unit 322 acquires the download address of the decoder module selected in step S15 from the firmware providing server 103, and sets the download address to the firmware download address list (step S16). Also, the encryption version comparison unit 322 acquires the download address of request firmware from the firmware providing server 103, and sets the download address to the firmware download address list (step S17).

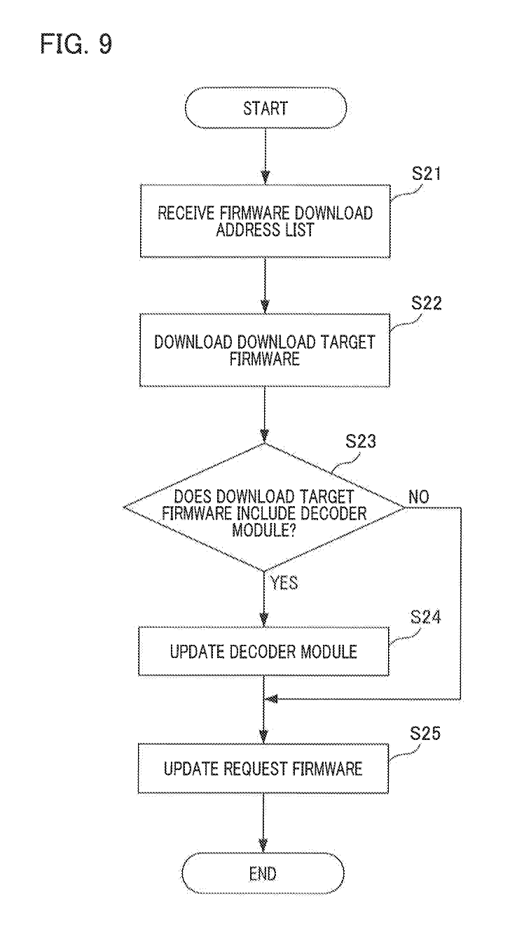

FIG. 9 is a flowchart illustrating an example of firmware update processing performed by an image forming apparatus. The firmware download unit 314 of the image forming apparatus 101 receives a firmware download address list from the provision unit 323 of the distribution managing server 102 via the network 104 (step S21).

Next, the firmware download unit 314 downloads download target firmware from the download, address set in the firmware download address list received in step S21 (step S22). With this arrangement, download target firmware is distributed from the firmware providing server 103 to the image forming apparatus 101.

In the process in step S22, the firmware provision unit 331 of the firmware providing server 103 functions as a distribution unit that executes the following processing. The firmware provision unit 331 distributes the decoder module to the image forming apparatus 101 using a first communication path (communication path using HTTPS), and distributes request firmware to the image forming apparatus 101 using a second communication path, (communication path using HTTP).

Next, the firmware update unit 315 determines whether or not download target firmware includes the decoder module (step S23). When download target firmware does not include the decoder module, download target firmware only includes request firmware. Also, the fact that download target firmware does not include the decoder module means the fact that the provision unit 323 of the distribution managing server 102 has not selected the decoder module, that is, the fact that the image forming apparatus 101 can decode request firmware.

When download target firmware does not include the decoder module, the process advances to step S25, and the firmware update unit 315 updates request firmware. More specifically, the firmware update unit 315 decodes request firmware using the decoder module included in current firmware. Then, the firmware update unit 315 updates current firmware with the decoded request firmware using update software included in current firmware.

When download target firmware includes the decoder module, download target firmware includes the decoder module and request firmware. The fact that download target firmware includes the decoder module means the fact that the provision unit 323 of the distribution managing server 102 has selected the decoder module, that is, the fact that the image forming apparatus 101 cannot decode request firmware. When download target firmware includes the decoder module, the process advances to step S24.

In step 324, the firmware update unit 315 executes decoder module update processing (step S24). More specifically, the firmware update unit 315 decodes the decoder module included in download target firmware using the decoder module included in current firmware. Then, the firmware update unit 315 updates the decoder module included in current firmware with the decoded decoder module using update software included in current firmware.

Next, the firmware update unit 315 updates request firmware (step S25). More specifically, the firmware update unit 315 decodes request firmware included in download target firmware using the decoder module updated in step S24. Then, the firmware update unit 315 updates current firmware with the decoded request firmware.

While, in the first embodiment, the distribution managing server 102 executes distribution management of firmware to the image forming apparatus 101, the distribution managing server 102 may also perform distribution management (for example, distribution management of application) of other data. Also, the firmware providing server 103 may be constituted by a plurality of servers, or may be a single server unique in the world. Also, the distribution managing server 102 may be adopted to run on the same server as the distribution managing server 102. The network 104 may also by a closed network such as an infra-company LAN, WAN, or the like.

For example, instead of running the decoder module as software included in firmware, the decoder module may also be independently executable software. When the decoder module is independently executable, the firmware provision unit 331 of the firmware providing server 103 transmits the decoder module alone and request firmware to the image forming apparatus 101.

The image forming apparatus 101 that has downloaded the decoder module and request firmware executes the following processing. The image forming apparatus 101 decodes and updates the decoder module, and decodes request firmware using the updated decoder module.

The firmware provision unit 331 may transmit the decoder module to the image forming apparatus 101 prior to distribution of request firmware. Then, the firmware provision unit 331 may distribute request firmware to the image forming apparatus 101 after application of the decoder module to the linage forming apparatus 101.

Next, a description will be given on a network system of a second embodiment. In the second embodiment, the distribution managing server 102 stores correspondence information (hereinafter referred to as “version correspondence information”) between the corresponding encryption version and the current firmware version of the image forming apparatus 101 in a storage unit in advance.

The firmware update request unit 313 sets the current firmware version to a firmware update request instead of the corresponding encryption version, and transmits the firmware update request to the distribution managing server 102.

The encryption version comparison unit 322 of the distribution managing server 102 refers to version correspondence information, and acquires the corresponding encryption version that corresponds to the version of current firmware included in the firmware update request received by the image forming apparatus 101. Then, the encryption version comparison unit 322 determines whether or not the acquired corresponding encryption version matches the encoded version of request firmware, and determines whether or not download target firmware can be decoded based on the determination result.

As described above, according to the network system of the present invention, an image forming apparatus, which does not correspond to a new encoding scheme, is capable of decoding and updating a program set to be updated encoded by the new encoding scheme. Thus, for example, even when firmware, which a user wishes to update, is encoded by an encoding scheme that cannot be decoded by the decoding function held by the image forming apparatus, firmware can be updated.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described, with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-029518 filed Feb. 15, 2011, which is hereby incorporated by reference herein in its entirety.

What is claimed is:

1. A network system comprising:
an image forming apparatus; and
a distribution server that distributes an encoded program set to the image forming apparatus,
wherein the distribution server comprises:
a determination unit configured to determine whether or not the image forming apparatus has already corresponded to an encoding scheme of the program set;
a communication path establishment unit configured to establish a first communication path having a higher security level than that of a second communication path when the image forming apparatus has not yet corresponded to the encoding scheme of the program set; and
a distribution unit configured to distribute a program, which is applied to the image forming apparatus so as to correspond to the encoding scheme, to the image forming apparatus using the first communication path and to distribute the program set encoded by the encoding scheme to the image forming apparatus using the second communication path.

2. The network system according to claim 1, wherein the distribution unit transmits a program applied to correspond to the encoding scheme to the image forming apparatus prior to distribution of the program set encoded by the encoding scheme, and distributes the program set encoded by the encoding scheme to the image forming apparatus after the image forming apparatus has applied the program.

3. A program set distribution method to be performed by a system comprising:
an image forming apparatus; and
a distribution server that distributes an encoded program set to the image forming apparatus,
wherein the program set distribution method comprises:
determining whether or not the image forming apparatus has already corresponded to an encoding scheme of the program set by the distribution server;
establishing a first communication path having a higher security level than that of a second communication path by the distribution server when the image forming apparatus has not yet corresponded to the encoding scheme of the program set; and
distributing a program by the distribution server, which is applied to the image forming apparatus so as to correspond to the encoding scheme, to the image forming apparatus using the first communication path and distributing the program set encoded by the encoding scheme to the image forming apparatus using the second communication path.

4. A distribution server that distributes an encoded program set to an image forming apparatus, the distribution server comprising:
a distribution unit configured to distribute a program, which is applied to the image forming apparatus so as to correspond to the encoding scheme, to the image forming apparatus prior to distribution of the program set encoded by the encoding scheme using a first communication path having a higher security level than that of a second communication path when the image forming apparatus has not yet corresponded to the encoding scheme of the program set,
wherein the distribution unit distributes the program set encoded by the encoding scheme to the image forming apparatus using the second communication path after the image forming apparatus has applied the program.

5. A method for controlling a distribution server that distributes an encoded program set to an image forming apparatus, the method comprising:
distributing a program, which is applied to the image forming apparatus so as to correspond to the encoding scheme, to the image forming apparatus prior to distribution of the program set encoded by the encoding scheme using a first communication path having a higher security level than that of a second communication path when the image forming apparatus has not yet corresponded to the encoding scheme of the program set; and
distributing the program set encoded, by the encoding scheme to the image forming apparatus using the second communication path after the image forming apparatus has applied the program.

6. A computer readable storage medium on which is stored a storage medium for making a computer execute a method for controlling a distribution server that distributes an encoded program set to an image forming apparatus, the method comprising:
distributing a program, which is applied to the image forming apparatus so as to correspond to the encoding scheme, to the image forming apparatus prior to distribution of the program set encoded by the encoding scheme using a first communication path having a higher security level than that of a second communication path when the image forming apparatus has not yet corresponded to the encoding scheme of the program set; and
distributing the program set encoded by the encoding scheme to the image forming apparatus using the second communication path after the image forming apparatus has applied the program.
